(19) United States
(12) Patent Application Publication
(10) Pub. No.: US 2014/0176814 A1
(43) Pub. Date: Jun. 26, 2014

(54) WEARABLE DISPLAY DEVICE

(71) Applicant: ELECTRONICS AND TELECOMMUNICATIONS RESEARCH INSTITUTE, Daejeon-si (KR)

(72) Inventor: Chung Hyun AHN, Daejeon-si (KR)

(73) Assignee: Electronics and Telecommunications Research Institute, Daejeon-si (KR)

(21) Appl. No.: 13/773,126

(22) Filed: Feb. 21, 2013

(30) Foreign Application Priority Data
Dec. 20, 2012 (KR) 10-2012-0131346

(51) Int. Cl. G02B 27/01; G10L 15/22; H04N 5/232

(52) U.S. Cl. CPC G02B 27/017; H04N 5/23293; G10L 15/22
USPC 348/739; 345/8; 348/333.01; 704/275; 455/566; 455/552.1

(57) ABSTRACT

The present invention provides a wearable display device which enables the visually impaired, hearing impaired, and disabled to live a normal living and furthermore, enables them to enjoy various benefits due to the advancement of IT.

A wearable display device according to the present invention comprises a communication control module controlling transmission and reception of a signal; a signal processing module processing the signal input to the communication control module and extracting information from the signal; and a display module being worn by a user in the form of glasses and displaying the information.

### CROSS-REFERENCE TO RELATED APPLICATIONS

This application claims the benefit of priority of Korean Patent Application No. 10-2012-0131346 filed on Dec. 20, 2012, which is incorporated by reference in their entirety herein.

### BACKGROUND OF THE INVENTION

1. Field of the Invention

The present invention relates to a wearable display device and more particularly, a wearable display device worn by a user in the form of glasses and displaying predetermined information for the user.

2. Discussion of the Related Art

Information technology (IT) including location based services making use of global positioning system (GPS) and indoor location technology; display technology; wireless communication technology; and so on provides the users with a host of benefits such as convenience of living.

Particularly, advancement of display technology has reached a point of commercialization of thin film type of flexible display and about 4 inch size of OLED flexible display has been recently developed.

Meanwhile, location technology enabling various kinds of location-based services in a smart-phone era has advanced to a point where accuracy of indoor location information relying on a base station or Wi-Fi is characterized in the range of tens to hundreds meters, in addition to outdoor localization by employing GPS signals.

In addition, wireless communication such as the fourth-generation mobile communication is now capable of servicing a large capacity video directly through a communication network while close-proximity wireless communication technology based on Wi-Fi is making N-screen technology widely distributed, which enables seamless connectivity between television and smart devices.

It is true that many people benefit from the advancement of IT but it is also true that there are people neglected including the visually impaired or hearing impaired, senior citizens, and the like who do not enjoy the benefits of IT.

People with low vision whose eyesight has been weakened due to innate or acquired impairments cannot watch television at the same position as normal people. Similarly in the case of reading a book, those people have to put a magnifying glass on the book and hold their eye close to the glass to see characters, having a difficulty in obtaining visual information as well as enjoying culture. Moreover, since those people cannot see the foreground scene clearly, their mobility is considerably restricted. Therefore new devices are being developed to improve eyesight of people with low vision based on cameras.

However, since those devices depend only on images captured through a camera, there is an apparent limitation for those people with low vision to live a life like normal people and as stated above, enjoying the full benefits from the advancement of IT is also not easy for those people.

### SUMMARY OF THE INVENTION

The present invention has been made in an effort to provide a wearable display device enabling the visually impaired, hearing impaired, and the disabled to overcome the visual and aural barrier.

To solve the technical problems above, the present invention provides a wearable display device comprising a communication control module controlling transmission and reception of a signal; a signal processing module processing the signal input to the communication control module and extracting information from the signal; and a display module being worn by a user in the form of glasses and displaying the information.

The wearable display device further comprises a camera module being connected to the display module, capturing an image along the same direction as the sight of the user, and displaying the captured image on the display module.

The wearable display device further comprises a voice input module being connected to the communication control module and receiving a voice of the user and voices around the user.

The signal processing module processes a voice signal input to the voice input module and extracts the voice signal into the form of text, where the text is displayed on the display module.

The signal processing module of the wearable display device extracts voice from the signal and the wearable display device further comprises a voice output module being connected to the signal processing module and outputting voice extracted from the signal.

The wearable display device further comprises a navigation module being connected to the communication control module and receiving position information of the user and based on the information, providing route guide information for the user.

The navigation module comprises a position information receiving unit receiving position information of the user; a map controller storing a map and being connected to the communication control module and controlling the map according to a map control signal input by the user; and a direction indicating unit displaying a moving direction of the user on the display module according to the map control signal.

The navigation module further comprises a map view generation module being connected to the map controller and displaying the map on the display module by changing the view form of the map according to the map control signal.

The wearable display device further comprises a communication module being connected to the communication control module and transmitting and receiving the signal to and from an external device.

The communication module is one of wireless communication modules employing short range wireless communication including Wi-Fi and Bluetooth.

The communication module is one of wireless communication modules employing mobile communication technology including the third generation mobile communication and fourth generation mobile communication.

The wearable display device further comprises a TV receive module being connected to the communication control module and receiving a digital broadcasting signal.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 illustrates a wearable display device according to a first embodiment of the present invention;

FIG. 2 is a perspective view of a display module of a wearable display device according to a first embodiment of the present invention;

FIG. 3 illustrates a wearable display device according to a second embodiment of the present invention;

FIG. 4 illustrates a wearable display device according to a third embodiment of the present invention;

FIG. 5 illustrates a wearable display device according to a fourth embodiment of the present invention; and

FIG. 6 illustrates a wearable display device according to a fifth embodiment of the present invention.

### DETAILED DESCRIPTION OF THE INVENTION

### First Embodiment

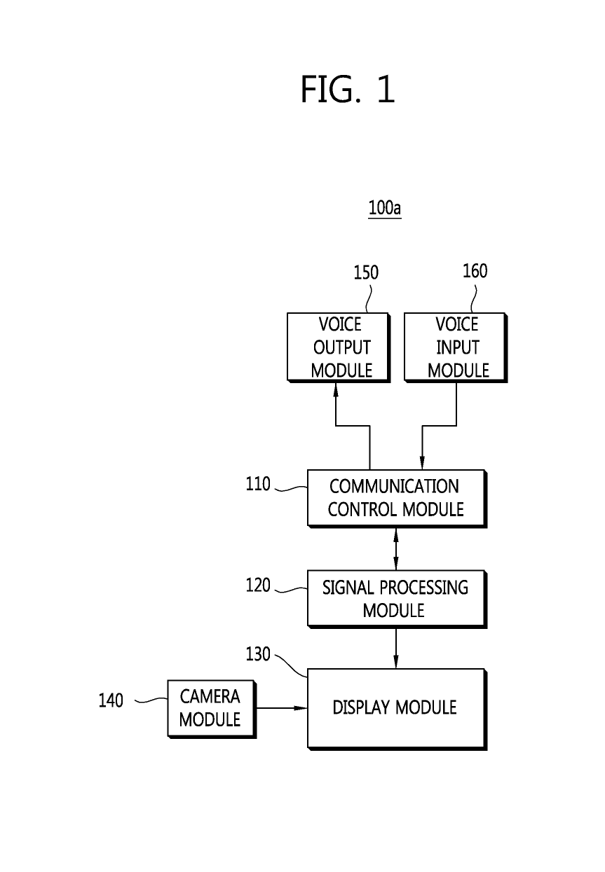

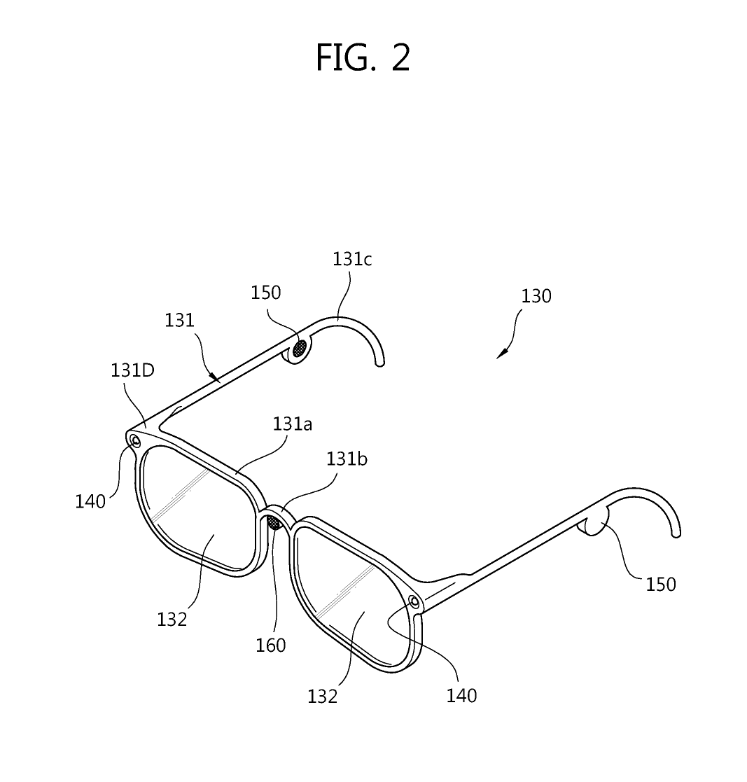

FIG. 1 illustrates a wearable display device according to a first embodiment of the present invention. FIG. 2 is a perspective view of a display module of a wearable display device according to a first embodiment of the present invention.

With reference to FIGS. 1 and 2, a wearable display device 100a according to a first embodiment comprises a communication control module 110, a signal processing module 120, and a display module 130.

The communication control module 110 controls transmission and reception of at least one of a voice signal and an image signal. The signal processing module 120 processes a signal received from the communication control module 110 and extracts the corresponding information from the signal. The display module 130 is prepared in the form of glasses and worn by the user. In other words, the display module 130 comprises a frame 131 and a display unit 132.

The frame 131 comprises eyewire 131a supporting the display unit 132, bridge 131b supported by the nose of the user, temple 131c supported by the ear of the user, and end piece 131d connecting the eyewire 131a and the temple 131c.

The display unit 132, being supported by the eyewire 131a, is disposed in the front of the eyes of the user. The display unit 132 display information extracted from the signal processing module 120. The information displayed on the display unit 132 can be displayed in the form of image, character, and so on. The display unit 132 may use a flexible display device.

Meanwhile, the frame 131 can be equipped with a camera module 140, voice input module 160, and voice output module 150.

The camera module 140 can be installed at the endpiece 131d of the frame 131. The camera module 140 captures images along the same direction as the sight of the user. The captured images are displayed on the display module 130. At this time, if a wide angle lens is employed for the camera module 140, an image captured with a field of view wider than that of the human can be displayed.

The voice output module 150 can be installed at the temple 131c of the frame 131. The voice output module 150 outputs voice information extracted from the signal processing module 120. Therefore, the user can hear voice information extracted from the signal processing module 120.

The voice input module 160 can be installed at the bridge 131b of the frame 131. A microphone can be used for the voice input module 160.

The voice input module 160 receives the user's voice. Therefore the user can easily input control commands to control the display device through his or her voice.

Also, the voice input module 160 receives voices around the user. The voices input through the voice input module 160 are output through the voice output module 150 and input to the communication control module 110 and converted into characters by the signal processing module 120 and displayed on the display module 132.

In what follows, a wearable display device according to the first embodiment and other embodiments will be described.

In what follows, for the convenience of description, the same reference symbols are assigned to the constituent elements similar to a wearable display device according to the first embodiment and detailed descriptions related to the constituent elements will be omitted. Therefore, in what follows, those elements for which detailed descriptions are omitted could be understood from the description about the wearable display device according to the first embodiment.

### Second Embodiment

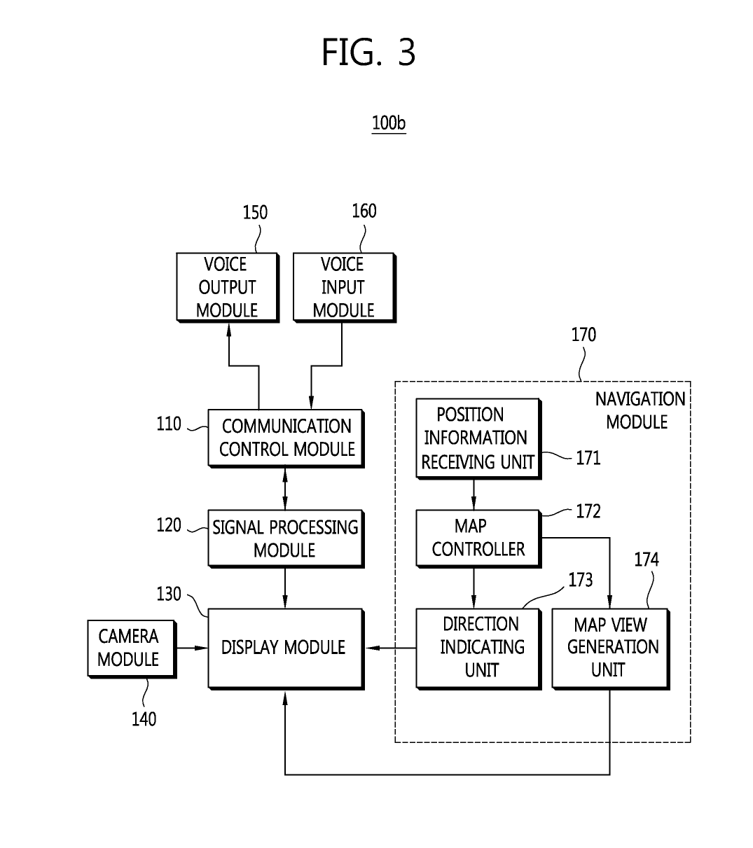

FIG. 3 illustrates a wearable display device according to a second embodiment of the present invention.

With reference to FIG. 3, a wearable display device 100b according to a second embodiment comprises a communication control module 110, a signal processing module 120, a display module 130, and a navigation module 170.

The navigation module 170 can be installed at the frame 131. The navigation module 170 comprises a position information receiving unit 171, a map controller 172, and a direction indicating unit 173. A GPS receiver may be used for the position information receiving unit 171. The position information receiving unit 171 receives position information of the user wearing a display module 130. The map controller 172 is connected to the communication control module 110. The map controller 172 controls a map according to a map control signal input of the user. The direction indicating unit 173 displays on the display module 130 a direction along which the user has to move from his or her current position toward a destination position set by the user.

The navigation module 170 can further comprise a map view generation unit 174 connected to the map controller 172. The map view generation unit 174, according as the map control signal of the user is received, converts a viewing mode of the map into, for example, a 2D view mode, 3D view mode, night mode, daytime mode, magnification mode, reduction mode, and so on and displays the converted map on the display module 130.

As stated above, the wearable display device 100b according to the second embodiment comprises a navigation module 170 and receives a current position of the user and carry out a route guide toward a destination point set by the user.

### Third Embodiment

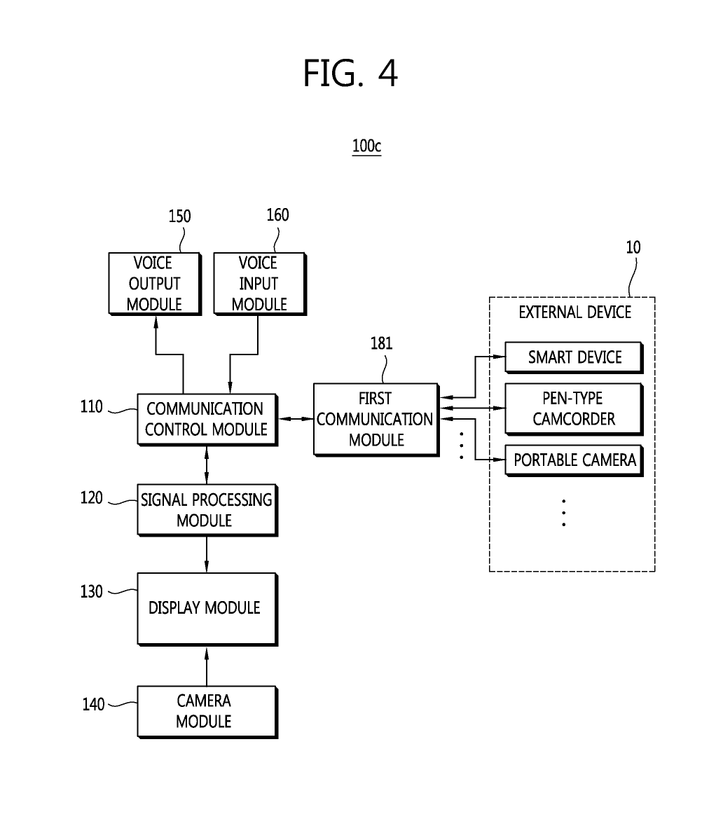

FIG. 4 illustrates a wearable display device according to a third embodiment of the present invention.

With reference to FIG. 4, a wearable display device 100c according to a third embodiment comprises a communication control module 110, a signal processing module 120, a display module 130, and a first communication module 181.

A wireless communication module employing short range wireless communication technology such as Wi-Fi, Bluetooth, and so on can be used for the first communication module 181. The first communication module 181 can be connected to an external device 170 which can be carried by the user and is capable of short range communication such as a smart device, portable camera, pen-type camcorder, and so on.

Therefore, a wearable display device 100c according to the third embodiment receives data stored in a smart device, images captured by a portable camera, images scanned by a pen-type camcorder, and the like and displays the corresponding information on the display module 130 or through the voice output module 150.

### Fourth Embodiment

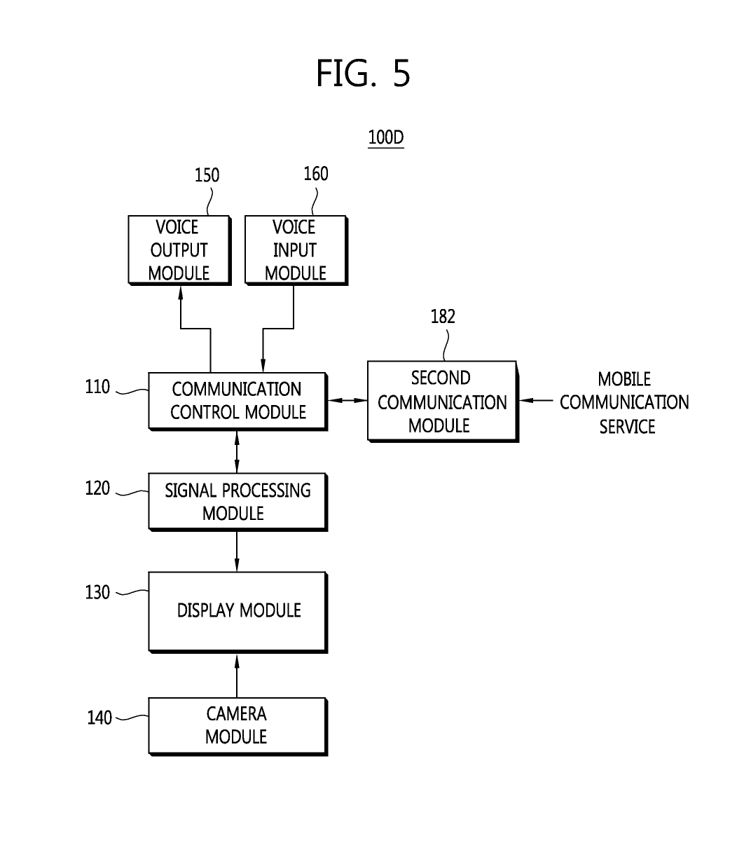

FIG. 5 illustrates a wearable display device according to a fourth embodiment of the present invention.

With reference to FIG. 5, a wearable display device 100d according to a fourth embodiment comprises a communication control module 110, a signal processing module 120, a display module 130, and a second communication module 182. A mobile communication module employing mobile communication technology such as the third generation (3G) mobile communication and the fourth generation (4G) mobile communication and so on can be used for the second communication module 182. The second communication module 182 described above can be connected to a mobile communication service network provided by mobile communication service providers.

Therefore, a wearable display device 100d according to the fourth embodiment can display a mobile communication service (for example, a route guide service) on the display module 130 or through the voice output module 150.

### Fifth Embodiment

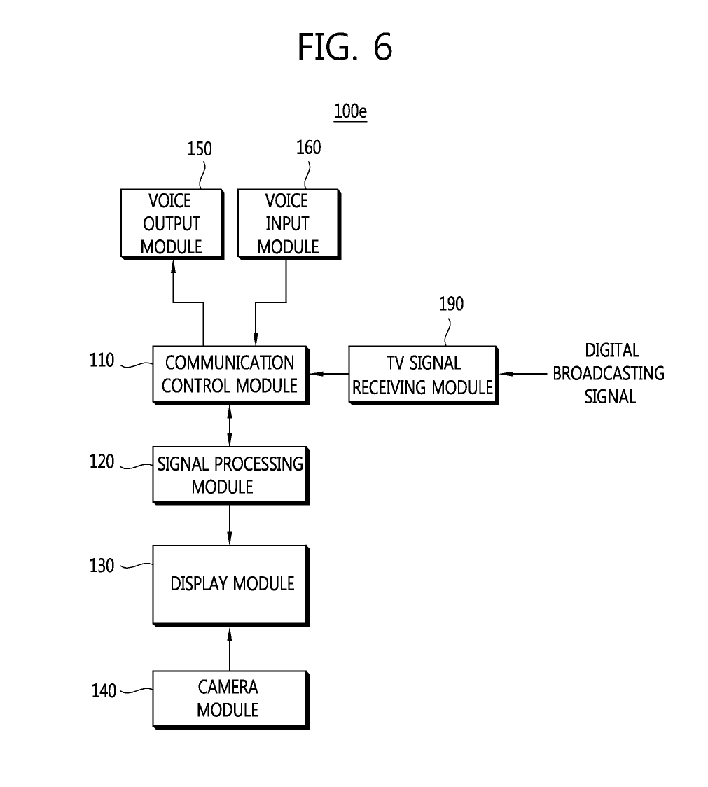

FIG. 6 illustrates a wearable display device according to a fifth embodiment of the present invention.

With reference to FIG. 6, a wearable display device 100e according to a fifth embodiment comprises a communication control module 110, a signal processing module 120, a display module 130, and a TV signal receiving module 190. The TV signal receiving module 190 can receive a digital broadcasting signal.

Therefore, the wearable display device 190 according to the fifth embodiment can display contents provided by a broadcasting station on the display module 130 or through the voice output module 150.

As described above, the wearable display device 100a, 100b, 100c, 100d, 100e according to the present invention can display information on the display module 130 or output voice information through the voice output module 150. Therefore, the display device according to the present invention 100a, 100b, 100c, 100d, 100e enables a normal person to receive more abundant information while walking and enables the visually impaired, hearing impaired, and disabled to live a normal living and furthermore, enables them to enjoy various benefits due to the advancement of IT.

What is claimed is:

1. A wearable display device, comprising:
a communication control module controlling transmission and reception of a signal;
a signal processing module processing the signal input to the communication control module and extracting information from the signal; and
a display module being worn by a user in the form of glasses and displaying the information.

2. The wearable display device of claim 1, further comprising a camera module being connected to the display module, capturing an image along the same direction as the sight of the user, and displaying the captured image on the display module.

3. The wearable display device of claim 1, further comprising a voice input module being connected to the communication control module and receiving a voice of the user and voices around the user.

4. The wearable display device of claim 3, wherein the signal processing module processes a voice signal input to the voice input module and extracts the voice signal into the form of text and the text is displayed on the display module.

5. The wearable display device of claim 1, wherein the signal processing module extracts a voice from the signal, further comprising a voice output module being connected to the signal processing module and outputting voice extracted from the signal.

6. The wearable display device of claim 1, further comprising a navigation module being connected to the communication control module and receiving position information of the user and based on the information, providing route guide information for the user.

7. The wearable display device of claim 6, wherein the navigation module comprises
a position information receiving unit receiving position information of the user;
a map controller storing a map and being connected to the communication control module and controlling the map according to a map control signal input by the user; and
a direction indicating unit displaying a moving direction of the user on the display module according to the map control signal.

8. The wearable display device of claim 7, wherein the navigation module further comprises a map view generation module being connected to the map controller and displaying the map on the display module by changing a view form of the map according to the map control signal.

9. The wearable display device of claim 1, further comprising a communication module being connected to the communication control module and transmitting and receiving the signal to and from an external device.

10. The wearable display device of claim 9, wherein the communication module is one of wireless communication modules employing short range wireless communication including Wi-Fi and Bluetooth.

11. The wearable display device of claim 9, wherein the communication module is one of wireless communication modules employing mobile communication technology including the third generation (3G) mobile communication and fourth generation (4G) mobile communication.

12. The wearable display device of claim 1, further comprising a TV receive module being connected to the communication control module and receiving a digital broadcasting signal.
